(19) United States
(12) Patent Application Publication
(10) Pub. No.: US 2014/0231360 A1
(43) Pub. Date: Aug. 21, 2014

(54) NH3 Feed-Forward Control of Blower Output

(71) Applicants: Amanda Lee Poole, Chicago, IL (US); David James Green, Batavia, IL (US); Christopher Todd Sosnowski, Crystal Lake, IL (US)

(72) Inventors: Amanda Lee Poole, Chicago, IL (US); David James Green, Batavia, IL (US); Christopher Todd Sosnowski, Crystal Lake, IL (US)

(21) Appl. No.: 13/768,782

(22) Filed: Feb. 15, 2013

(51) Int. Cl. C02F 3/00

(52) U.S. Cl. CPC C02F 3/006
USPC 210/739; 210/96.1

(57) ABSTRACT

A system for treating wastewater includes an aeration tank having a plurality of air diffusers located within the tank. Air delivery equipment provides air to the tank via air diffusers. An ammonia sensor located near or upstream of the wastewater inlet is used by a controller to measure the ammonia content of the wastewater at the inlet. The controller then modifies the actual airflow provided to the tank based on a prediction of the level of air flow required to fully treat the wastewater before it reaches the outlet and controls the air source to provide the predicted level of air flow.

### TECHNICAL FIELD OF THE DISCLOSURE

The present disclosure relates to treatment of wastewater and, more particularly, relates to a system and method for the treatment of wastewater via aeration using feed-forward control based on ammonia content.

### BACKGROUND OF THE DISCLOSURE

Water is one of the most abundant substances on our planet. However, sources of clean fresh water, crucial to the continued health and survival of many species, are less abundant. Humans use a large amount of fresh water each day for waste removal, resulting in a large stream of sewage, or untreated wastewater. In its raw form, such untreated wastewater cannot be returned to the environment without creating a biological hazard. For example, untreated waste can be toxic to many species, can cause overgrowth of undesirable algae, and can cause numerous other ecological problems. Thus, sewage treatment facilities are used to treat the raw wastewater prior to returning the water to the environment.

However, wastewater treatment can often be an inefficient energy-intensive process, and as such can be costly. In addition, the excessive use of energy resources often results in the introduction of toxic emissions into the environment, e.g., from the burning of coal, gas, natural gas, etc. A large portion of the high energy usage in the treatment of wastewater is often primarily due to the need to aerate the wastewater, often through the use of large electrically-powered air blowers. In activated sludge treatment, the aeration process provides dissolved oxygen in the water to facilitate the breakdown of waste materials in the water through biological processes. Aeration also provides mixing energy to the liquor. However, the need to provide such aeration can account for as much as 75% of a typical treatment plant's daily energy consumption. In part due to this, municipal water and wastewater treatment in the U.S. accounts for as much as 5% of the national energy consumption.

Contributing to inherent inefficiencies, a lack of advanced control systems increases the energy usage of the process. In those facilities with aeration control systems, a typical process for wastewater treatment generally measures the dissolved oxygen wastewater in the mixed liquor to ensure that the dissolved oxygen throughout the activated sludge or aeration process maintains at least a minimum level for effective treatment. However, this process introduces a lag in treatment adaptation, i.e., a change in air delivery equipment output , when the nature of the incoming waste stream changes. For example, a rapid change in the wastewater, so that it more quickly depletes the dissolved oxygen in the water will not be detected until a low dissolved oxygen level is detected in that water when the biological system responds, and it finally reaches the end of the treatment tank. The oxygen demand in typical wastewater is primarily established by two main constituents: organics (measured as biological oxygen demand) and ammonia.

The present disclosure is directed at least in part to a system that may address the need for a more efficient and effective system for wastewater treatment, particularly with respect to the activated sludge stage. However, it should be appreciated that the solution of any particular problem is not a limitation on the scope of this disclosure nor of the attached claims except to the extent expressly noted. Additionally, the inclusion of material in this Background section is not an indication that the material represents known prior art other than material associated with a patent number, publication number or other indicia of publication. With respect to any such identified prior art, the foregoing characterization is not itself prior art but is simply a brief summary for the sake of reader convenience. The interested reader is referred to the identified documents themselves for a more accurate understanding.

### SUMMARY OF THE DISCLOSURE

In accordance with one aspect of the present disclosure, a method is provided for treating wastewater to reduce air delivery equipment response time and provide improved controllability based on the level of ammonia in the wastewater. The method includes receiving the wastewater into an aeration tank. The aeration tank includes multiple air diffusers that supply air to the tank via air delivery equipment (e.g. an air blower). The ammonia level in the wastewater near the tank inlet is determined and the output of the air source is adjusted primarily based on that measurement such that a dissolved oxygen level in the effluent wastewater remains within a predetermined optimal range. For the purposes of this disclosure, ammonia and ammonium are used interchangeably.

In accordance with another aspect of the disclosure, a wastewater treatment system is provided for treatment of wastewater using air. The system includes a tank having a plurality of air diffusers located within the tank. An air source is connected to the air diffusers for providing an air flow into the tank. An ammonia sensor located near the wastewater tank inlet is used by a controller to measure the ammonia content of the wastewater as it enters the tank. The control system then renders a prediction of the level of air flow required to fully treat the wastewater before it reaches the outlet and controls the air source to provide the predicted level of required air.

Other features and advantages of the disclosed systems and principles will become apparent from reading the following detailed disclosure in conjunction with the included drawing figures.

### BRIEF DESCRIPTION OF THE DRAWINGS

FIG. 1 is schematic of a wastewater treatment system within which embodiments of the invention may be implemented;

FIG. 2 is a schematic diagram of a treatment tank and associated components and systems in an example system;

FIG. 3 is a plot showing an ammonia breakthrough in the system of FIG. 2;

FIG. 4 is a schematic diagram of a treatment tank and associated components and systems in accordance with an aspect of the disclosure;

FIG. 5 is a plot showing ammonia control in the system of FIG. 4; and

FIG. 6 is a flow chart illustrating a process of wastewater treatment in accordance with an aspect of the disclosure.

### DETAILED DESCRIPTION OF THE DISCLOSURE

As noted above, the cost of energy at wastewater treatment plants represents a considerable portion of the operating expenses for a municipality or utility. Aeration is a fundamental yet expensive component for biological treatment, typically representing 25-75% of the overall energy consumption. The proposed system will provide superior energy savings and response to dynamic loadings by controlling the air supplied to the biological processes based on influent ammonium measurements. In particular, control of airflow to the tanks based on upstream ammonia measurements allows the influent ammonia level to be used to predict the actual airflow required for oxidizing organics as well as ammonia.

Ammonium is one of the predominant species that exerts an oxygen demand in wastewater treatment, exerting an oxygen demand over four times as strong as typical organic (i.e. BOD) loadings. In an embodiment of the invention, the described process measures ammonium using ion selective electrode (ISE) probes in the upstream end of the aeration system. The signals are used in conjunction with other parameters to control the speed and/or output of the air delivery equipment (e.g., blowers, compressors, etc.) such that the rate of change of air delivery is adjusted based on the influent ammonia.

This system allows the process to self-regulate based on past system performance. A pilot study demonstrated 11% energy savings for the present system when compared to dissolved oxygen-based control. Moreover, the system provides more stable operations by allowing a faster response to dynamic loading when compared to a manual or effluent-based control system. Thus, the benefits of the system described herein include both energy savings and improved process control.

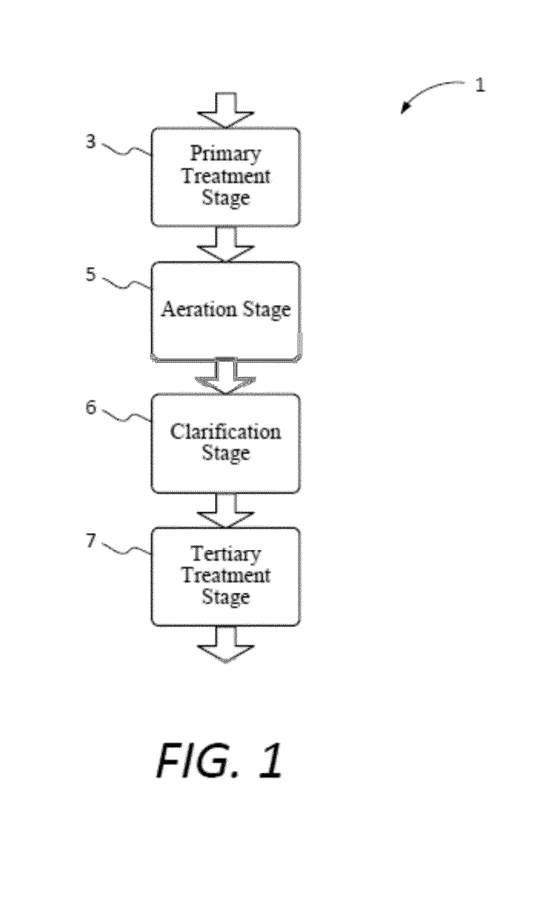

Having given the above overview and referring now more specifically to the drawing figures, FIG. 1 is a high-level schematic diagram of a wastewater treatment facility including components in a wastewater treatment tank. Water enters the illustrated wastewater treatment system 1 via a primary treatment stage 3, which may include screening, grit removal, or clarification. The primary treatment stage 3 is intended to remove solid particles from the water prior to aeration.

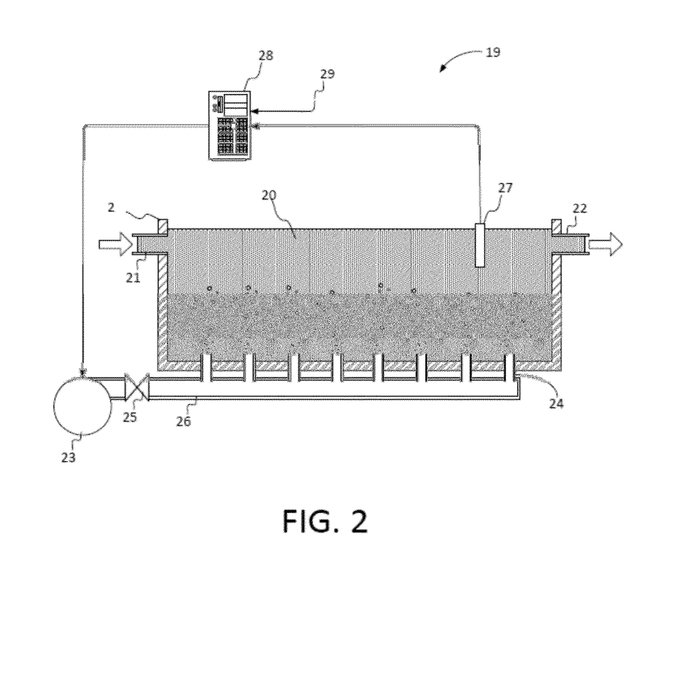

The primary process effluent then flows or may be pumped to secondary treatment. The secondary treatment includes an aeration stage 5, which includes one or more aeration tanks 2 (shown in FIG. 2), and clarification. As discussed elsewhere herein, aeration in the tanks 2 provides mechanical energy for mixing and also provides oxygen to facilitate the biological decomposition of ammonia and organics in the water. From the aeration stage 5, wastewater enters settling and clarification tanks (clarification stage 6). After this secondary treatment process, a tertiary step, including a physical/chemical cleaning stage 7 may follow.

As can be seen, an important part of the wastewater treatment system 1 of FIG. 1 is the aeration tank 2. In a typical existing system, as illustrated schematically in the diagram 19 of FIG. 2, wastewater 20 flows through, or may occasionally be held in, the aeration tank 2. The wastewater 20 is input to the aeration tank 2 at the upstream end via one or more inlets 21 (there may be multiple inlets or a single inlet), flows through the aeration tank 2, and exits the tank at the downstream end via one or more outlets 22 (there may be multiple outlets or a single outlet). The water within the aeration tank 2 will vary from containing high levels of organics and ammonia either at the upstream end or near the inlet 21 to low levels either near the outlet 22 or at the downstream end. At typical flow rates, the hydraulic residence time in the aeration tank 2 ranges from 2 to 24 hours.

In addition to the tank inlet 21 and the tank outlet 22, the tank 2 also includes air diffusers 24. The diffusers distribute air that is supplied to the tank by the air delivery equipment 23. Within the tank 2, the injected air rises through the wastewater 20, aerating and mixing the wastewater 20. As the wastewater 20 is aerated, oxygen from the injected air dissolves into the wastewater 20. As noted above, the oxygen facilitates biological activity that results in the reduction of organics and ammonia in the wastewater.

In practice, the air delivery equipment 23 may be driven by an electrically-powered motor drive. In some cases, the drive may be a variable-speed drive, although such is not required. Additionally or alternatively, a valve 25 may be provided to throttle the air delivery equipment 23 either upstream or downstream of the air delivery equipment 23. A conduit or manifold 26 distributes the output of the air blower 23 to the one or more air diffusers 24 in one or more tanks. Although shown as a straight walled conduit, the conduit or manifold 26 may be tapered or otherwise shaped to ensure essentially even distribution of the injected air among the one or more air diffusers 24.

In a typical installation, several dissolved oxygen sensors may be in the tank. However, typical controlled aeration systems control is based on a dissolved oxygen sensor 27 located in the tank 2 near the outlet 22. The dissolved oxygen sensor (or sensors) 27 senses the level of dissolved oxygen in the wastewater at the location of the sensor 27 in the tank 2. A computer, controller, PLC, PAC, or other processing device 28 receives an input from the dissolved oxygen sensor 27 and determines whether the sensed level of dissolved oxygen meets a given preset optimum value identified via a setpoint 29 to the process.

In response to detecting an amount of dissolved oxygen that diverges too much from the identified optimum value, the computer, controller, PLC, PAC, or other processing device 28 provides a control command directly or indirectly to the air blower 23 to adjust the air delivered to tank 2. For example, if the dissolved oxygen level is too low, the control command sends more air to the tank 2 to meet the desired setpoint 29. Similarly, if the dissolved oxygen level is too high, and thus wasteful, the control command causes the air delivery equipment 23 to reduce output, provide less air, and save energy. Those of skill in the art will appreciate that air flow into the tank 2 may be controlled by controlling the blower as described above, or may alternatively or additionally be controlled via control of the valve 25.

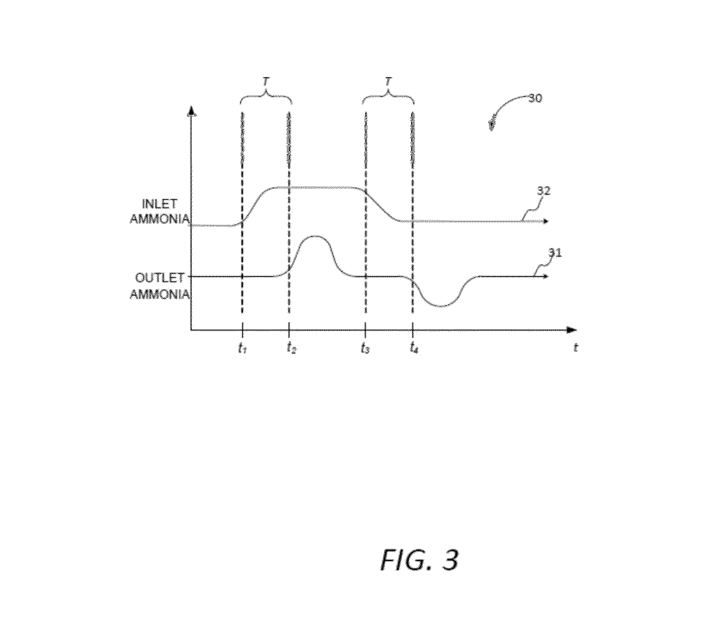

However, as noted above, systems such as this that are based on dissolved oxygen feedback have certain drawbacks such as: (1) slow response time of the air delivery equipment that can result in allowing temporary but significant spikes in the level of ammonium in the effluent wastewater, and (2) requiring a greater air flow than needed to ensure proper treatment. Regarding these points, the graph 30 of FIG. 3 simulates the ammonium level 31 of the input wastewater and the ammonium level 32 of the output wastewater as a function of time.

At an arbitrary time t₀, the ammonium level in the inlet water (influent) and the ammonium level in the outlet water (effluent) are both stable in time. At a time t₁, the ammonium level 31 in the influent begins to rise, e.g., due to a change in the source or ammonium level of the inlet water. Because the dissolved oxygen sensor 27 is located near the outlet 22, the system does not sense the increased ammonium levels until a time t₂, which is a time T later than t₁, T being the transit time of water within the tank 2 plus time necessary for the biological system to respond. At time t₂, the system increases the air to the tank 2, bringing the ammonium level at the outlet 22 down to its original level after a spike in ammonium at the outlet 22.

Similarly, at a time t₃, the ammonium level in the influent drops to its original level. After a transit time T, the ammonium level at the outlet 22 drops, returning the aeration system to optimal performance. After a brief drop in ammonium at the outlet 22, the system returns the aeration to its original level and the ammonium level at the outlet 22 stabilizes at its original level. Thus, it can be seen that the typical system can result in both under-aeration (with resulting under-treatment) and over-aeration (and resulting waste of energy).

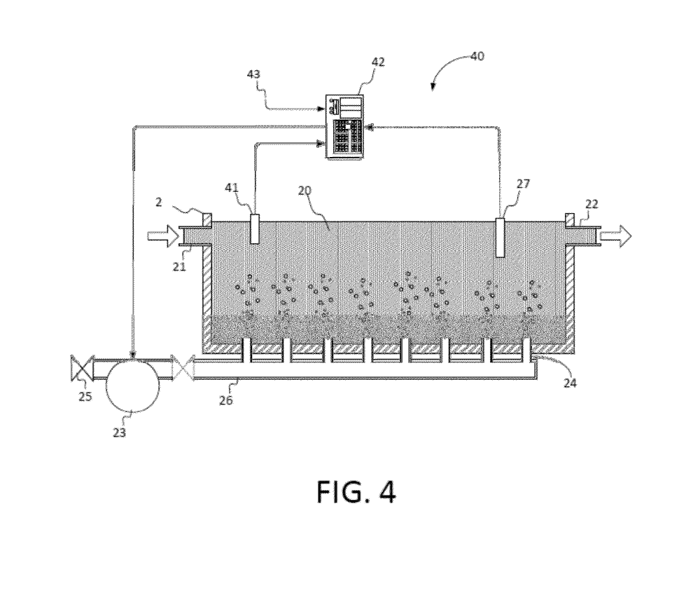

In an embodiment of the invention, a novel plant configuration and control system are provided to minimize the issues of over-aeration (energy waste) and under-aeration (ammonia break-through) present in existing systems. In overview, the system diagram 40 in accordance with an embodiment of the invention as shown in FIG. 4 includes a tank such as the aeration tank 2 for holding the wastewater 20. As in existing systems, the wastewater 20 flows through or is held in the aeration tank 2. The tank has one or multiple inlets 21 through which wastewater enters the tank and one or multiple outlets 22 through which wastewater exits the aeration system. Similarly, the tank 2 also includes air delivery equipment 23, connected and configured to force air to flow through one or more air diffusers 24 into the tank 2. A valve 25 may be provided to throttle the input and/or output of the air blower 23 and a conduit or manifold 26 distributes the output of the air blower 23 to the one or more air diffusers 24 in one or multiple tanks.

Any number of dissolved oxygen probes may be present in the tank 2. A controlling dissolved oxygen sensor 27 is not required, but if used may be located in the tank 2 near the outlet 22. More importantly, an ammonia sensor 41 is located near the inlet 21. The ammonia sensor 41 may be located within the tank 2 as shown or may alternatively be located outside the tank or upstream of the tank, e.g., in the inlet 21 or in a conduit or tank located upstream from the inlet 21. As noted above, the ammonia sensor 41 may be comprised of one or many ion selective electrode (ISE) probes depending on tank configuration.

The output of the ammonia sensor 41 is provided to the computer, controller, PLC, PAC, or other processing device 42 (hereinafter the “controller”). The controller 42 also receives an ammonia setpoint, e.g., via input 43. After executing a process to be described in greater detail later, the controller 42 provides a control command to control the air flow into the tank 2 via the air delivery equipment 23 and/or the valve 25. In an embodiment of the invention, the control command produces a variable frequency drive (VFD) control signal. In another embodiment of the invention, the control command produces a valve position control signal. In overview, the process executed by the controller 42 determines an optimal air flow based on the level of ammonia in the influent in conjunction with other plant parameters. The controller 42 subsequently adjusts the airflow, e.g., the rate of change of air to the tank may be proportional to the rate of change of the influent ammonia.

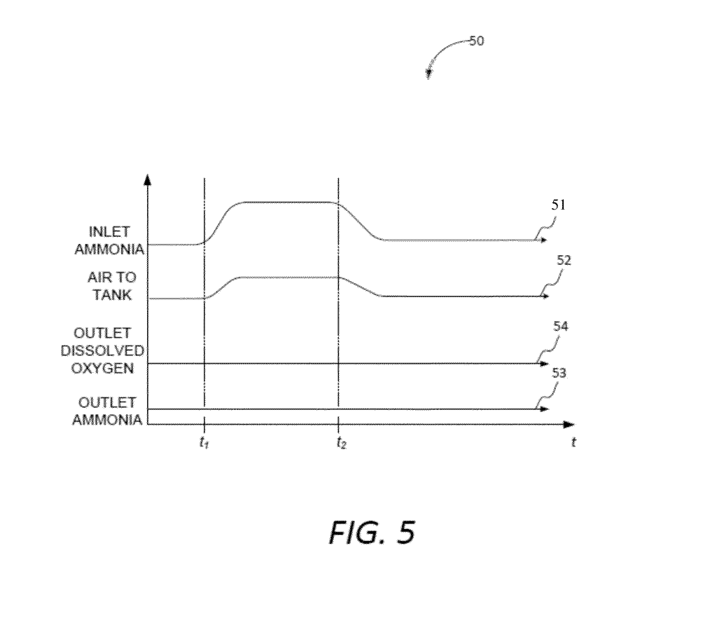

The plot 50 of FIG. 5 shows a simulated representation of the influent ammonia level 51, air flow 52 into the diffusers, effluent dissolved oxygen 54, and the effluent ammonia level 53 as a function of time. As can be seen, the influent ammonia level 51, air flow 52, dissolved oxygen 54, and effluent ammonia level 53 are all in steady state equilibrium initially. At time t1, the influent ammonia level 51 begins to rise. Consistent with data from the ammonia sensor 41, the controller 42 controls the air delivery equipment 23 to increase the air to the tank.

Although there will be a very small delay to account for computation time and blower acceleration time, the increased airflow occurs at substantially the same time and at a rate that is adjusted according to the influent ammonia level 51. In response to the increased airflow, a greater degree of biological activity in the tank 2 reduces the effluent ammonia level 53 such that it remains essentially stable at its initial level.

Subsequently at time t2, the influent ammonia level 51 begins to fall. Again consistent with data from the ammonia sensor 41, the controller 42 controls the air delivery equipment 23 to maintain or decrease the airflow at the time and proportional rate of the decrease in the influent ammonia level 51. As a consequence, due to the decreased air flow coinciding with the decreased influent ammonia level 51, the effluent ammonia level 53 maintains a stable level. As with existing systems, the controller 42 may account for a minimum dissolved oxygen level and minimum airflow rate in making a calculation of air flow delivery.

Depending upon the implementation, there may be a small delay between changes in the influent ammonia level 51 and changes in air flow due to computation time and air output acceleration time. However, for practical purposes, the increased airflow occurs at substantially the same time and rate as the increase in influent ammonia level 51.

### Industrial Applicability

In general terms, the present disclosure sets forth a system and method applicable to the treatment of wastewater. In particular, the disclosed system and method use a novel ammonia feed forward control strategy to predictively adjust the air flow in the aeration tank to accommodate changes in the influent ammonia content.

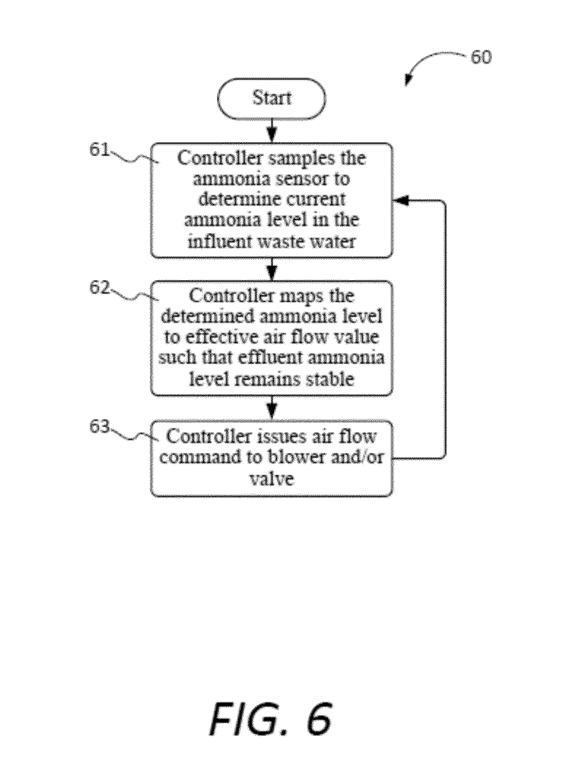

The flow chart 60 of FIG. 6 illustrates a process of wastewater treatment control in accordance with an embodiment of the disclosed principles. At stage 61 of the process 60, the controller 42 reads the ammonia sensor 41 to determine a current ammonia level in the influent wastewater as measured in the tank inlet, outside of the tank near the tank inlet, or outside of the tank. The controller 42 then maps the determined ammonia level, in conjunction with other setpoints, to an effective air flow value needed to treat the wastewater such that the ammonia level in the effluent remains at a desired value (e.g., zero or some small value) at stage 62.

In an alternative embodiment, the controller 42 may calculate the effective air flow rather than using a map or chart. Moreover, although the controller 42 is said to convert an influent ammonia level to an effective air flow, it will be appreciated that the controller 42 may instead convert the influent ammonia level directly to a blower speed, blower current, blower voltage, valve position, total required airflow, pressure, or other parameter usable to modify the air flow.

At stage 63, the controller 42 issues an air flow command to the blower 23 and/or valve 25. The air flow command may be a blower speed or airflow command, a blower voltage command, a blower current command, a valve position command, or other command for altering the air flow in the tank 2. Implementation of the airflow command at the air delivery equipment 23 and/or valve results in providing aeration in the tank 2 at a level needed to keep the dissolved oxygen stable and within a given range, and to minimize or produce effluent ammonia levels within a given range. A control loop is used to constantly monitor the process from stage 61 to stage 63 and back to stage 61.

It will be appreciated that the present disclosure provides a system and method for managing wastewater treatment in an efficient and effective manner. While only certain embodiments have been set forth herein, alternatives and modifications will be apparent from the above description to those skilled in the art. These and other alternatives are considered equivalents and within the spirit and scope of this disclosure and the appended claims.

What is claimed is:

1. A method for treating a wastewater to facilitate removal of ammonia and/or organics in the wastewater, the method comprising:
receiving an effluent wastewater into one or more aeration tank, wherein the wastewater flows into the one or more tanks via one or more inlets, is treated in one or more tanks, and flows out of the one or more tanks via one or more outlets to yield an effluent wastewater, the one or more tanks having a plurality of air diffusers therein supplied via an air source;
determining an ammonia level in the wastewater near the one or more tank inlets; and
based on the determined ammonia level in the wastewater near the one or more tank inlets, adjusting the operation of the air source such that the delivered air modulates to match predicted process requirements in order to assist in the optimization of dissolved oxygen and/or ammonia levels.

2. The method in accordance with claim 1, further comprising measuring the dissolved oxygen level in the wastewater aeration system via a dissolved oxygen sensor.

3. The method in accordance with claim 2, further comprising receiving a dissolved oxygen setpoint corresponding to the optimum dissolved oxygen level.

4. The method in accordance with claim 3, wherein adjusting the operation of the air source such that a dissolved oxygen level in the effluent wastewater remains within a predetermined range of an optimal dissolved oxygen level includes transmitting a control signal to the air source to modify an air flow provided to the plurality of air diffusers.

5. The method in accordance with claim 1, wherein the air source comprises a blower.

6. The method in accordance with claim 1, wherein the air source comprises a compressor.

7. The method in accordance with claim 1, wherein determining an ammonia level in the wastewater near the one or more tank inlets comprises reading an ammonia sensor located within the one or more tanks near the one or more tank inlets.

8. The method in accordance with claim 1, wherein determining an ammonia level in the wastewater near the one or more tank inlets comprises reading an ammonia sensor located outside of the one or more tanks near the one or more tank inlets.

9. The method in accordance with claim 1, wherein determining an ammonia level in the wastewater near the one or more tank inlets comprises reading an ammonia sensor located upstream of the one or more tanks.

10. A wastewater treatment system for treating a stream of wastewater, the system comprising:
one or more aeration tanks having one or more wastewater inlets and one or more wastewater outlets;
a plurality of air diffusers located within the one or more aeration tanks;
an air source connected to the plurality of air diffusers for providing an air flow thereto;
an ammonia sensor located near the one or more wastewater inlets; and
a controller configured to measure an ammonia content of the wastewater via the ammonia sensor and to render a prediction of the level of air flow required to fully treat the wastewater before it reaches the one or more outlets based on the measured level of ammonia, and to control the air source to provide the predicted air flow.

11. The wastewater treatment system in accordance with claim 10, further comprising a dissolved oxygen sensor configured to measure the dissolved oxygen level in the aeration system.

12. The wastewater treatment system in accordance with claim 10, further comprising a dissolved oxygen sensor near the one or more tank outlets.

13. The wastewater treatment system in accordance with claim 10, wherein the air source comprises a blower.

14. The wastewater treatment system in accordance with claim 10, wherein the air source comprises a compressor.

15. The wastewater treatment system in accordance with claim 10, wherein the ammonia sensor is located within the one or more tanks near the one or more tank inlets.

16. The wastewater treatment system in accordance with claim 10, wherein the ammonia sensor is located outside of the one or more tanks near the one or more tank inlets.

17. The wastewater treatment system in accordance with claim 10, wherein the ammonia sensor located upstream of the one or more tanks.
